(19) United States
(12) Patent Application Publication
(10) Pub. No.: US 2024/0152500 A1
(43) Pub. Date: May 9, 2024

(54) Graph Transformation Method, Apparatus and System of Function Block Chain

(71) Applicant: Siemens Aktiengesellschaft, München (DE)

(72) Inventors: Wen Chao Zou, Shanghai (CN); Hai Feng Wang, Shanghai (CN)

(73) Assignee: Siemens Aktiengesellschaft, München (DE)

(21) Appl. No.: 18/549,239

(22) PCT Filed: Mar. 12, 2021
(86) PCT No.: PCT/CN2021/080575

§ 371 Date: Sep. 6, 2023

(51) Int. Cl. G06F 16/22

(52) U.S. Cl. CPC G06F 16/2255

(57) ABSTRACT

Various embodiments of the teachings herein include a graph transformation method of a function block chain. The method may include: extracting a plurality of function block pairs from a function block chain, wherein the function block chain comprises a plurality of function blocks connected in sequence; respectively transforming the function block pairs into nodes; transforming the nodes into directed acyclic graphs or undirected acyclic graphs; and building a graph of the function block chain based on the directed acyclic graphs/undirected acyclic graphs and a weight served by the count.

### CROSS-REFERENCE TO RELATED APPLICATIONS

This application is a U. S. National Stage Application of International Application No. PCT/CN2021/080575 filed Mar. 12, 2021, which designates the United States of America, the contents of which are hereby incorporated by reference in their entirety.

### TECHNICAL FIELD

The present disclosure relates to the field of digitization. Various embodiments of the teachings herein include graph transformation methods, apparatus, and systems of a function block chain.

### BACKGROUND

In the field of graphical programming, programs are mainly built with a bunch of compression or packing functions of a graphical block, wherein the graphical block may be multiplexed. A knowledge graph is a popular expression manner to utilize such function block (such as recommendation and program generation. Ideally, the knowledge graph may be built to represent one function block by each node and represent a connection between two function blocks by a connection between each node. However, many programs will be built with frequently multiplexed function blocks, which may probably create a circulation in the graph. Some function blocks will be directly connected to themselves. Some other graphs will circulate with each other. Cyclic graphs will not adapt to any existing graph learning algorithm. It is not just graphic programming, but all software that uses reusable elements to build a process has such problems.

FIG. 1 is a schematic diagram of a PLC function block chain (Function Block Chain) and a direct transformation graph thereof, wherein the PLC function block chain is a conveyor driven by an engine. A function block chain B1 includes a first function block B11, a second function block B12, a third function block B13, a fourth function block B14, a fifth function block B15, a sixth function block B16, a seventh function block B17, an eighth function block B18 and a ninth function block B19. The first function block B11 refers to STATUS (Current), the second function block B12 refers to STATUS (Voltage), the third function block B13 refers to STATUS (Revolution), the fourth function block B14 refers to INPUT (Current, Voltage), the fifth function block B15 refers to STATUS (Current), the sixth function block B16 refers to STATUS (Voltage), the seventh function block B17 refers to STATUS (Revolution), the eighth function block B18 refers to OUTPUT (Revolution), and the ninth function block B19 refers to STATUS (Velocity). Particularly, the device is the conveyor, and the velocity refers to a velocity of the conveyor. Specifically, the above-mentioned function block chain controls a motor, which uses three “STATUS” function blocks to check a current, a voltage and a revolution (rpm) of the engine in sequence, then inputs the current and the voltage to the motor after it is determined that the current, the voltage and the revolution of the above-mentioned engine are normal, then checks whether the three “STATUSES” corresponding to the current, the voltage and the revolution are normal again, and then outputs the revolution to the conveyor. Then, the motor checks the velocity status of the conveyor. According to the technical solutions of the prior art, the above-mentioned function block chain B1 is directly transformed into a graph G1. In the graph G1, although the “STATUS” function block has different targets, unprocessed function blocks are the same. If we directly transform such a function block chain into one graph, we will get three circulations, including “STATUS” to “STATUS”, “STATUS” to “INPUT” to “STATUS”, and “STATUS” to “OUTPUT” to “STATUS”.

In order to solve the circulation problems of the cyclic graph mentioned above, the prior art provides several solutions. One of the solutions is to transfer the circulation caused by edges between a pair of problematic nodes to provide a simplified graph without circulation. However, this way will lead to information loss of the graph. Another solution is that the cyclic nodes are merged into a super node, so the circulation is attached into the super node. However, this solution can only solve a mixed graph, in which all the circulations are not linked to each other but separated by edges without circulation, so this solution cannot solve the above problems. Therefore, the prior art tends to be simplified, in which all problematic elements are removed so that other simplified graphs can be executed.

### SUMMARY

Some embodiments of the present disclosure include a graph transformation method of a function block chain, including: S1. extracting a plurality of function block pairs from a function block chain, wherein the function block chain includes a plurality of function blocks connected in sequence; S3. respectively transforming the function block pairs into nodes; S4. transforming the nodes into directed acyclic graphs or undirected acyclic graphs; and S5. building a graph of the function block chain based on the directed acyclic graphs/undirected acyclic graphs and a weight served by the count.

In some embodiments, the nodes are twin nodes.

In some embodiments, after S1, the method further includes: S2. classifying the function block pairs according to a self-circulation type and a bidirectional circulation type, and counting the function block pairs of the self-circulation type and the bidirectional circulation type respectively, and the step S3 further includes: respectively transforming the function block pairs of different types into twin nodes.

In some embodiments, the types include self-circulation and bidirectional circulation, and the step S3 further includes: for the function block of the self-circulation type, transforming the nodes corresponding to the function block into twin nodes of in-degree and out-degree of one connection; and for the function block of the bidirectional circulation type, duplicating any node corresponding to the function block, and then re-connecting with another node to transform into twin nodes of in-degree and out-degree of two connections.

In some embodiments, the function block pair refers to every two function blocks and a mutual relationship therebetween.

In some embodiments, the node is a triple node, and the triple node includes two adjacent sub-function blocks and a parent function block and mutual connections therebetween.

In some embodiments, S3 further includes respectively transforming the function block pairs into triple nodes and counting co-occurrences of two adjacent triple nodes.

In some embodiments, wherein when the function block chain includes a connecting branch between the function blocks, the sub-function blocks in the triple node on the branch are mutually connected with the parent function block of adjacent nodes.

In some embodiments, when the triple node is based on the co-occurrence thereof, the graph transformation method of a function block chain further includes the following step of: replicating the node based on co-occurrences thereof in the graph to become a twin replicated node, and then connecting the node with the twin node thereof.

As another example, some embodiments of the present disclosure include a graph transformation system of a function block chain, including: a processor; and a memory coupled to the processor, the memory having instructions stored therein, the instructions, when executed by the processor, causing the processor to execute actions, the actions including: S1. extracting a plurality of function block pairs from a function block chain, wherein the function block chain includes a plurality of function blocks connected in sequence; S3. respectively transforming the function block pairs into nodes; S4. transforming the nodes into directed acyclic graphs or undirected acyclic graphs; and S5. building a graph of the function block chain based on the directed acyclic graphs/undirected acyclic graphs and a weight served by the count.

In some embodiments, the nodes are twin nodes.

In some embodiments, after the action S1, the actions further include: S2. classifying the function block pairs according to a self-circulation type and a bidirectional circulation type, and counting the function block pairs of the self-circulation type and the bidirectional circulation type respectively, and the action S3 further includes: respectively transforming the function block pairs of different types into twin nodes.

In some embodiments, the types include self-circulation and bidirectional circulation, and the action S3 further includes: for the function block of the self-circulation type, transforming the nodes corresponding to the function block into twin nodes of in-degree and out-degree of one connection; and for the function block of the bidirectional circulation type, duplicating any node corresponding to the function block, and then re-connecting with another node to transform into twin nodes of in-degree and out-degree of two connections.

In some embodiments, the function block pair refers to every two function blocks and a mutual relationship therebetween.

In some embodiments, the node is a triple node, and the triple node includes two adjacent sub-function blocks and a parent function block and mutual connections therebetween.

In some embodiments, the action S3 further includes respectively transforming the function block pairs into triple nodes and counting co-occurrences of two adjacent triple nodes.

In some embodiments, wherein when the function block chain includes a connecting branch between the function blocks, the sub-function blocks in the triple node on the branch are mutually connected with the parent function block of adjacent nodes.

In some embodiments, when the triple node is based on the co-occurrence thereof, the actions further include: replicating the node based on co-occurrences thereof in the graph to become a twin replicated node, and then connecting the node with the twin node thereof.

As another example, some embodiments of the present disclosure include a graph transformation apparatus of a function block chain, including: an extracting apparatus which extracts a plurality of function block pairs from a function block chain, wherein the function block chain includes a plurality of function blocks connected in sequence; a first transforming apparatus which respectively transforms the function block pairs into nodes; a second transforming apparatus which transforms the nodes into directed acyclic graphs or undirected acyclic graphs; and a building apparatus which builds a graph of the function block chain based on the directed acyclic graphs/undirected acyclic graphs and a weight served by the count.

As another example, some embodiments of the present disclosure include a computer program product, the computer program product is tangibly stored on a computer readable medium and includes a computer executable instruction, and the computer executable instruction enables at least one processor to execute the method described according to the first aspect of the present invention when being executed.

As another example, some embodiments of the present disclosure include a computer-readable medium, storing computer-executable instructions, the computer-executable instructions, when being executed, causing at least one processor to perform the method according to the first aspect of the present invention.

The graph transformation mechanism of the function block chain provided by the present disclosure enables data of PLC or industrial software more valuable. Compared with the situation of unavailable data in the prior art, the above-mentioned data may be used in the knowledge graph calculation as described herein. The teachings of the present disclosure are applicable to all software, which means that all industrial data can be used to perform graph calculation by using the teachings herein, and this will greatly accelerate building of an industrial knowledge graph network. Moreover, the methods can be automatically executed at an engineering end in time, which means that users can easily adopt the present teachings, and can collect data and perform data preprocessing at an edge device end. All the prior arts mean information loss, but the various embodiments of the teachings herein can ensure that no information is lost, and all the connections of the initial function block chain can be saved in the graph of the subsequently transformed undirected acyclic graph, wherein a number of connections is equal to a sum of edge weights, which proves that all the connections of the initial function block chain are saved. For example, the graph that saves all the information of the initial function block chain can easily perform subsequent machine learning. Moreover, all the true co-occurrence information of the initial cyclic graph can be reflected and saved in the finally transformed acyclic graph.

### BRIEF DESCRIPTION OF THE DRAWINGS

FIG. 1 is a schematic diagram of a PLC function block chain (Function Block Chain) and a direct transformation graph thereof;

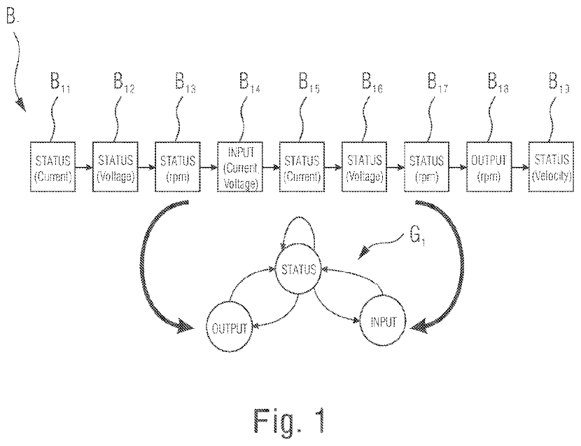

FIG. 2 is a schematic diagram of extracting function block pairs based on the PLC function block chain incorporating teachings of the present disclosure;

FIG. 3 is a schematic diagram of detecting a circulation based on a PLC function block chain incorporating teachings of the present disclosure;

FIG. 4 is a schematic diagram of building a graph by using a directed acyclic graph of a twin node based on the PLC function block chain incorporating teachings of the present disclosure;

FIG. 5 is a schematic diagram of building a graph by using an undirected acyclic graph of a twin node based on a PLC function block chain incorporating teachings of the present disclosure;

FIG. 6 is a schematic diagram of transforming the function block pairs into triple nodes based on the PLC function block chain incorporating teachings of the present disclosure;

FIG. 7 is a schematic diagram of transforming the function block pairs into triple nodes based on a PLC function block chain having a branch incorporating teachings of the present disclosure;

FIG. 8 is a schematic diagram of re-building a graph based on triple nodes and weights that are based on the PLC function block chain incorporating teachings of the present disclosure; and

FIG. 9 is a schematic diagram of a graph based on the PLC function block chain incorporating teachings of the present disclosure when the triple node is based on the co-occurrence thereof.

### DETAILED DESCRIPTION

Specific implementations of the teachings of the present disclosure are described below with reference to the accompanying drawings. Some embodiments include a graph transformation method, apparatus, and/or system of a function block chain, which can transform a cyclic graph into an acyclic graph. Function blocks enable a graph transformation mechanism not to simplify graph elements for removing node circulations, but also can realize the acyclic graph, which is convenient for subsequent machine learning, or the like.

Some embodiments include a graph transformation method of a function block chain, including the following:

At first, step S1 is executed to extract a plurality of function block pairs from a function block chain, wherein the function block chain includes a plurality of function blocks connected in sequence. That is, all the function block pairs are directly extracted from the initial function block chain, wherein each direct function block pair refers to one link in the initial function block, which includes two function blocks and connections thereof.

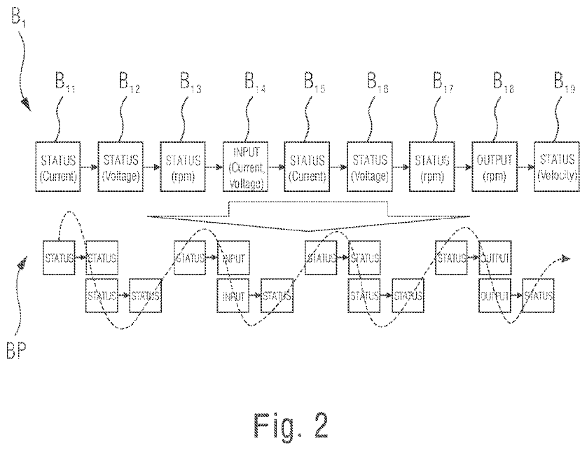

FIG. 2 is a schematic diagram of extracting function block pairs based on a PLC function block chain incorporating teachings of the present disclosure. The PLC function block chain is a conveyor driven by an engine. A function block chain B1 includes a first function block B11, a second function block B12, a third function block B13, a fourth function block B14, a fifth function block B15, a sixth function block B16, a seventh function block B17, an eighth function block B18 and a ninth function block B19. The first function block B11 refers to STATUS (Current), the second function block B12 refers to STATUS (Voltage), the third function block B13 refers to STATUS (Revolution), the fourth function block B14 refers to INPUT (Current, Voltage), the fifth function block B15 refers to STATUS (Current), the sixth function block B16 refers to STATUS (Voltage), the seventh function block B17 refers to STATUS (Revolution), the eighth function block B18 refers to OUTPUT (Revolution), and the ninth function block B19 refers to STATUS (Velocity). Particularly, the device is the conveyor, and the velocity refers to a velocity of the conveyor. Specifically, the above-mentioned function block chain controls a motor, which uses three “STATUS” function blocks to check a current, a voltage and a revolution (rpm) of the engine in sequence, then inputs the current and the voltage to the motor after it is determined that the current, the voltage and the revolution of the above-mentioned engine are normal, then checks whether the three “STATUSES” corresponding to the current, the voltage and the revolution are normal again, and then outputs the revolution to the conveyor. Then, the motor checks the velocity status of the conveyor.

In some embodiments, the function block pair refers to every two function blocks and a mutual relationship therebetween. Therefore, in these embodiments, eight function block pairs BP are obtained in total, which means that there are eight connections in the initial function block chain B1. As shown in FIG. 2, the function block pairs BP include: “STATUS” to “STATUS”, “STATUS” to “STATUS”, “STATUS” to “INPUT”, “INPUT” to “STATUS”, “STATUS” to “STATUS”, “STATUS” to “STATUS”, “STATUS to “OUTPUT”, and “OUTPUT” to “STATUS”.

Then, step S3 is executed to respectively transform the function block pairs into nodes. That is, a circulation is detected according to the extracted direct node. In some embodiments, the nodes are twin nodes.

In some embodiments, the graph is re-built by transforming into a directed acyclic graph. Therefore, after the step S1, the method further includes step S2: classifying the function block pairs, and counting the function block pairs of each type, wherein the step S3 further includes the following step of: respectively transforming the function block pairs of different types into twin nodes.

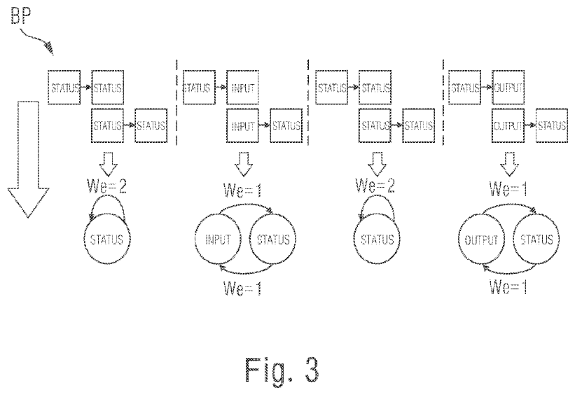

Specifically, the circulation may be generated from two types of connections, and the connections include type one and type two. Specifically, the types include self-circulation and bidirectional circulation. The self-circulation refers to anode connected to itself, and the bidirectional circulation refers to two nodes connected to each other twice with different connection directions. As shown in FIG. 3, the circulation detected in step S2 includes:
detecting the twice “STATUS” to “STATUS” of the function block pairs in the function block chain BP as the self-circulation type, wherein weights thereof are that We=2;
detecting the once “STATUS” to “INPUT” and the once “INPUT” to “STATUS” of the function block pairs in the function block chain BP as the bidirectional circulation, wherein weights thereof are that We=1;
detecting another twice “STATUS” to “STATUS” of the function block pairs in the function block chain BP as the self-circulation type, wherein weights thereof are that We=2; and
detecting the once “STATUS” to “OUTPUT” and the once “OUTPUT” to “STATUS” of the function block pairs in the function block chain BP as the bidirectional circulation, wherein weights thereof are both that We=1.

The step S3 further includes: for the function block of the self-circulation type, transforming the nodes corresponding to the function block into twin nodes of in-degree and out-degree of one connection; and for the function block of the bidirectional circulation type, duplicating any node corresponding to the function block, and then re-connecting with another node to transform into twin nodes of in-degree and out-degree of two connections. After circulation detection is executed, a twin node generation mechanism may automatically trigger to transform multiplexing elements in the cyclic graph structure to two twin nodes, one of which inherits the in-degree of the initial node and the out-degree of the other node.

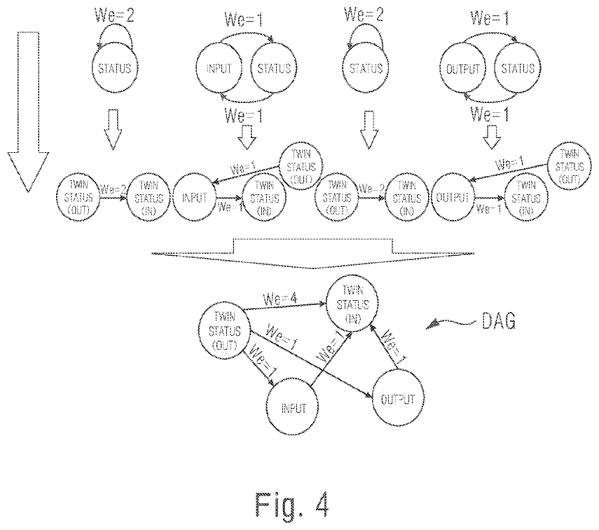

In some embodiments, for circulations of the self-circulation type, both a parent node and a child node of one connection are the same. Therefore, the self-circulation can be directly transformed from “TWIN [NODE NAME] (OUT-DEGREE)” “TWIN [NODE NAME] (OUT-DEGREE)” to “TWIN [NODE NAME] (IN-DEGREE)”. Specifically, as shown in FIG. 4, twice “STATUS” to “STATUS” can be transformed from “TWIN STATUS (OUT-DEGREE)” to “TWIN STATUS (IN-DEGREE)”, wherein a weight is that We=2.

For the bidirectional circulation, the node in the middle may not cause circulation, but there are other nodes on both sides of the node in the middle. Therefore, the bidirectional circulation can be directly transformed from “TWIN [NODE NAME] (OUT-DEGREE)” to “MIDDLE NODE NAME” to “TWIN [NODE NAME] (IN-DEGREE)”. As shown in FIG. 4, “STATUS” to “INPUT” to “STATUS” can be transformed from “TWIN STATUS (OUT-DEGREE)” to “INPUT” to “TWIN STATUS (IN-DEGREE)”, which are actually two connections from “TWIN STATUS (OUT-DEGREE)” to “INPUT” and “INPUT” to “TWIN STATUS (IN-DEGREE)” respectively, wherein a weight on the two connections is that We=1. Similarly, “STATUS” to “OUTPUT” to “STATUS” can be transformed from “TWIN STATUS (OUT-DEGREE)” to “OUTPUT” to “TWIN STATUS (IN-DEGREE)”, which are actually two connections from “TWIN STATUS (OUT-DEGREE)” to “OUTPUT” and “OUTPUT” to “TWIN STATUS (IN-DEGREE)” respectively, wherein a weight on the two connections is that We=1.

Finally, step S4 is executed, and the twin nodes are transformed into directed acyclic graphs or undirected acyclic graphs, so as to re-build a graph of the function block chain based on the directed acyclic graphs/undirected acyclic graphs and a weight served by the count. As shown in FIG. 4, the graph based on the directed acyclic graph DAG (Directed Acyclic Graph) include four nodes, which are respectively “TWIN STATUS (OUT-DEGREE)”, “TWIN STATUS (IN-DEGREE)”, “INPUT” and “OUTPUT”, wherein “TWIN STATUS (OUT-DEGREE)” respectively points to “TWIN STATUS (IN-DEGREE)”, “INPUT” and “OUTPUT”, while “INPUT” and “OUTPUT” respectively point to “TWIN STATUS (IN-DEGREE)”. The weight We is a count based on the weights of the twin nodes obtained in previous step. Therefore, “TWIN STATUS (OUT-DEGREE)” points to the weight (We=4) of “TWIN STATUS (IN-DEGREE)”, “TWIN STATUS (OUT-DEGREE)” points to the weight (We=1) of “OUTPUT”, “TWIN STATUS (OUT-DEGREE)” points to the weight (We=1) of “INPUT”, “INPUT” respectively points to the weight (We=1) of “TWIN STATUS (IN-DEGREE)”, and “OUTPUT” respectively points to the weight (We=1) of “TWIN STATUS (IN-DEGREE)”.

The present teachings are not only applicable to the directed acyclic graphs, but also applicable to the undirected acyclic graphs according to a variant of the present invention. The initial function block chain can be transformed into one undirected acyclic graph. The directed acyclic graphs DAG are different, and undirected acyclic graphs UAG (Undirected Acyclic Graph) mostly represent co-occurrence of nodes, so the twin nodes have different meanings. In some embodiments, for the nodes of the undirected acyclic graphs UAG, initial nodes are divided into in-degree nodes and out-degree nodes, wherein in nodes represent in-degrees of all the nodes and out-degree nodes represent all out-degrees. For the Co-occurrence Graph twin nodes, each twin node represents the replication of the initial node to solve the acyclic connection problem of one node.

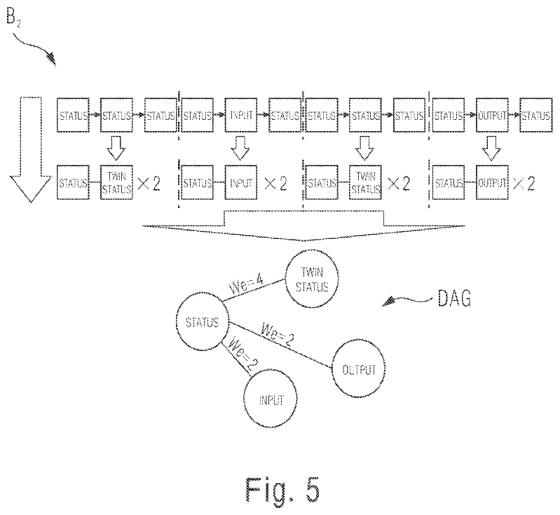

As shown in FIG. 5, a function block chain B2 includes the following function blocks in sequence: “STATUS” to “STATUS” to “STATUS”; “STATUS” to “INPUT” to “STATUS”; “STATUS” to “STATUS” to “STATUS”; and “STATUS” to “OUTPUT” to “STATUS”. Therefore, in step S3, the above-mentioned function blocks are transformed into twin nodes. Specifically, the “STATUS” of one twin node is transformed into “TWIN STATUS”. Because the co-occurrence does not include direction information, connections similar to “STATUS” to “INPUT” and “INPUT” to “STATUS” represent the same co-occurrence. Therefore, the count of the co-occurrence nodes is as follows:
it is counted that “STATUS” and “TWIN STATUS” co-occur for four times;
it is counted that “STATUS” and “INPUT” co-occur for twice; and
it is counted that “STATUS” and “OUTPUT” co-occur for twice.

Therefore, in step S3, “STATUS” to “STATUS” to “STATUS” is transformed into twice “STATUS” to “TWIN STATUS”, “STATUS” to “INPUT” to “STATUS” is transformed into twice “STATUS” to “INPUT”, and “STATUS” to “OUTPUT”. Then step S4 is executed. After co-occurrences are counted, all the counted co-occurrences are transformed into edge weights, and the twin nodes are transformed into undirected acyclic graphs. As shown in FIG. 4, the undirected acyclic graph DAG includes four nodes, which are respectively “STATUS”, “TWIN STATUS”, “INPUT” and “OUTPUT”. The weight We is a count based on the weights of the twin nodes obtained in previous step, so the weight We between “STATUS” and “TWIN STATUS” is 4, the weight We between “STATUS” and “INPUT” is 2, and the weight We between “STATUS” and “OUTPUT” is 2.

In some embodiments, the node is a triple node, and the triple node includes two adjacent sub-function blocks and a parent function block and mutual connections therebetween. The step S3 further includes respectively transforming the function block pairs into triple nodes and counting co-occurrences of two adjacent triple nodes.

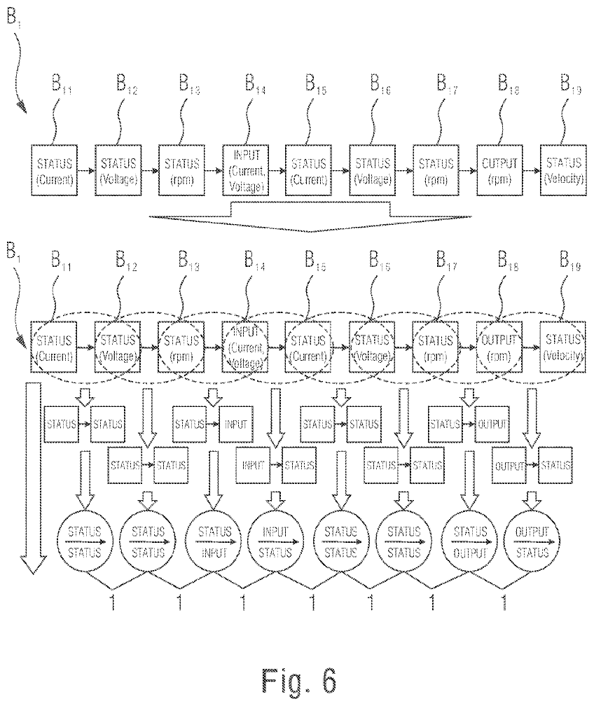

As shown in FIG. 6, the PLC function block chain is a conveyor driven by an engine. The function block chain B1 yet includes the following function blocks: STATUS (Current), STATUS (Voltage), STATUS (Revolution), INPUT (Current, Voltage), STATUS (Current), STATUS (Voltage), STATUS (Revolution), OUTPUT (Revolution), and STATUS (Velocity). In some embodiments, the device is the conveyor, and the velocity refers to a velocity of the conveyor. In some embodiments, the above-mentioned function block chain controls a motor, which uses three “STATUS” function blocks to check a current, a voltage and a revolution (rpm) of the engine in sequence, then inputs the current and the voltage to the motor after it is determined that the current, the voltage and the revolution of the above-mentioned engine are normal, then checks whether the three “STATUSES” corresponding to the current, the voltage and the revolution are normal again, and then outputs the revolution to the conveyor. Then, the motor checks the velocity status of the conveyor. Similarly, we can extract eight function block pairs: “STATUS” to “STATUS”, “STATUS” to “STATUS”, “STATUS” to “INPUT”, “INPUT” to “STATUS”, “STATUS” to “STATUS”, “STATUS” to “STATUS”, “STATUS” to “OUTPUT”, and “OUTPUT” to “STATUS”.

In some embodiments, the above-mentioned function block pairs are grouped to make every two interconnected function block pairs into one group, and then each group of the function block pairs above is transformed into a triple node. As shown in FIG. 6, the function block pair “STATUS” to “STATUS” is transformed into a triple node where a parent function block “STATUS” points to a sub-function block “STATUS”, the function block pair “STATUS” to “INPUT” is transformed into a triple node where a parent function block “STATUS” points to a sub-function block “INPUT”, the function block pair “INPUT” to “STATUS” is transformed into a triple node where a parent function block “INPUT” points to a sub-function block “STATUS”, the function block pair “STATUS” to “OUTPUT” is transformed into a triple node where a parent function block “STATUS” points to a sub-function block “OUTPUT”, and the function block pair “OUTPUT” to “STATUS” is transformed into a triple node where a parent function block “OUTPUT” points to a sub-function block “STATUS”. As shown in FIG. 6, the count between adjacent triple nodes is 1.

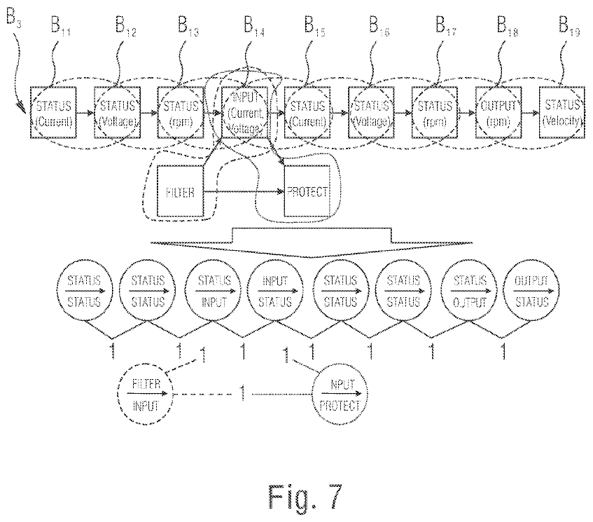

Particularly, the teachings of the present disclosure are not only applicable to function block chains with function blocks connected in sequence, but also applicable to function block chains with function blocks connected in sequence and function block connecting branches. Therefore, when the function block chain includes a connecting branch between the function blocks, the sub-function blocks in the triple node on the branch are mutually connected with the parent function block of adjacent nodes. As shown in FIG. 7, a function block chain part of a function block chain B3 connected in sequence is the same as the function block chain B1, and has the following function blocks: STATUS (Current), STATUS (Voltage), STATUS (Revolution), INPUT (Current, Voltage), STATUS (Current), STATUS (Voltage), STATUS (Revolution), OUTPUT (Revolution), and STATUS (Velocity). In addition, there is a function block branch on the “INPUT (Current, Voltage)”, and the branch includes two function blocks “FILTER” and “PROTECT”. The function block “FILTER” respectively points to the function block “INPUT (Current, Voltage) and the function block “PROTECT”, and “INPUT (Current, Voltage)” points to the function block “PROTECT”. That is, the filter inputs the current and the voltage, and the protection function may trigger protection measurement when an error occurs.

Specifically, as shown in FIG. 7, there is a co-occurrence between a triple node where a parent function block “STATUS” points to a sub-function block “INPUT” and a triple node where a parent function block “INPUT” points to a sub-function block “STATUS”, there is a co-occurrence between a triple node where a parent function block “FILTER” points to a sub-function block “INPUT” and a triple node where a parent function block “INPUT” points to a sub-function block “STATUS”, there is a co-occurrence between a triple node where a parent function block “STATUS” points to a sub-function block “INPUT” and a triple node where a parent function block “INPUT” points to a sub-function block “PROTECT”, there is a co-occurrence between a triple node where a parent function block “FILTER” points to a sub-function block “INPUT” and a triple node where a parent function block “INPUT” points to a sub-function block “PROTECT”, there is a co-occurrence between a triple node where a parent function block “STATUS” points to a sub-function block “INPUT” and a triple node where a parent function block “FILTER” points to a sub-function block “INPUT”, and there is a co-occurrence between a triple node where a parent function block “INPUT” points to a sub-function block “STATUS” and a triple node where a parent function block “INPUT” points to a sub-function block “PROTECT”. This fully illustrates the advantages of the present invention. The advantages of the present invention lie in retaining all the function blocks and connection information thereof, including the function blocks on the function block chain branches and connection information thereof.

Finally, step S4 and step S5 are executed, and the triple nodes are transformed into directed acyclic graphs or undirected acyclic graphs, and a graph of the function block chain is built based on the directed acyclic graphs/undirected acyclic graphs and the weight served by the count. The co-occurrence between two different triple nodes is transformed into an initial edge weight We between two triple nodes in the graph, and the co-occurrence between two identical triple nodes is transformed into an initial node weight Wv of one of the two identical triple nodes in the graph.

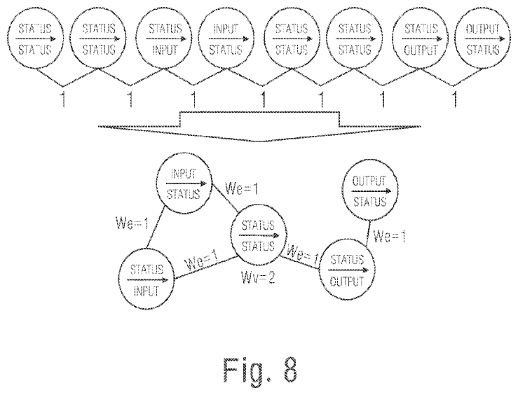

Specifically, as shown in FIG. 8, the triple nodes shown in FIG. 6 and the weights thereof are transformed into an undirected acyclic graph as shown in FIG. 8. The undirected acyclic graph includes five nodes, which are respectively a first triple node where a parent function block “STATUS” points to a sub-function block “STATUS”, a second triple node where a parent function block “STATUS” points to a sub-function block “INPUT”, a third triple node where a parent function block “INPUT” points to a sub-function block “STATUS”, a fourth triple node where a parent function block “STATUS” points to a sub-function block “OUTPUT”, and a fifth triple node where a parent function block “OUTPUT” points to a sub-function block “STATUS”. There is one co-occurrence respectively from the first triple node to the second triple node, the third triple node and the fourth triple node. Therefore, an edge weight We from the first triple node to the second triple node, the third triple node and the fourth triple node is 1 respectively. There is one co-occurrence between the third triple node and the second triple node; therefore, an edge weight We between the two is 1. There is one co-occurrence between the fourth triple node and the fifth triple node; therefore, an edge weight We between the two is 1. A weight coefficient Wv of the first triple node and itself is 1. There are two co-occurrences between the first triple node where the parent function block “STATUS” points to the sub-function block “STATUS” and itself; therefore, the first triple node has a weight that Wv=2.

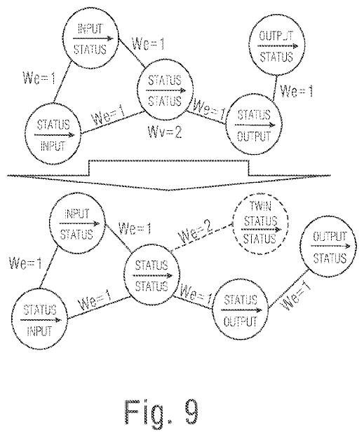

All the above weights are co-occurrence techniques. However, when a graph algorithm can only deal with edge weights, some nodes are inevitably not included. Therefore, preferably, when the triple node is based on the co-occurrence thereof, the graph transformation method of a function block chain further includes: replicating the node based on co-occurrences thereof in the graph to become a twin replicated node, and then connecting the node with the twin node thereof. As shown in FIG. 9, the first triple node is replicated into a twin replicated node where a parent function block “STATUS” points to a sub-function block “STATUS”, and then the weight that Wv=2 between the first triplet node and itself is transformed into the edge weight We, while the weight between the first triplet node and the twin replicated node is still that We=2.

As another example, some embodiments of the present disclosure include a graph transformation system of a function block chain, including: a processor; and a memory coupled to the processor, the memory having instructions stored therein, the instructions, when executed by the processor, causing the processor to execute actions, the actions including: S1. extracting a plurality of function block pairs from a function block chain, wherein the function block chain includes a plurality of function blocks connected in sequence; S3. respectively transforming the function block pairs into nodes; S4. transforming the nodes into directed acyclic graphs or undirected acyclic graphs; and S5. building a graph of the function block chain based on the directed acyclic graphs/undirected acyclic graphs and a weight served by the count.

In some embodiments, the nodes are twin nodes.

In some embodiments, after the action S1, the actions further include: S2. classifying the function block pairs according to a self-circulation type and a bidirectional circulation type, and counting the function block pairs of the self-circulation type and the bidirectional circulation type respectively, and the action S3 further includes: respectively transforming the function block pairs of different types into twin nodes.

In some embodiments, the types include self-circulation and bidirectional circulation, and the action S3 further includes for the function block of the self-circulation type, transforming the nodes corresponding to the function block into twin nodes of in-degree and out-degree of one connection; and for the function block of the bidirectional circulation type, duplicating any node corresponding to the function block, and then re-connecting with another node to transform into twin nodes of in-degree and out-degree of two connections.

In some embodiments, the function block pair refers to every two function blocks and a mutual relationship therebetween.

In some embodiments, the node is a triple node, and the triple node includes two adjacent sub-function blocks and a parent function block and mutual connections therebetween.

In some embodiments, the action S3 further includes respectively transforming the function block pairs into triple nodes and counting co-occurrences of two adjacent triple nodes.

In some embodiments, wherein when the function block chain includes a connecting branch between the function blocks, the sub-function blocks in the triple node on the branch are mutually connected with the parent function block of adjacent nodes.

In some embodiments, when the triple node is based on the co-occurrence thereof, the actions further include: replicating the node based on co-occurrences thereof in the graph to become a twin replicated node, and then connecting the node with the twin node thereof.

As another example, some embodiments of the present disclosure include a graph transformation apparatus of a function block chain, including: an extracting apparatus which extracts a plurality of function block pairs from a function block chain, wherein the function block chain includes a plurality of function blocks connected in sequence; a first transforming apparatus which respectively transforms the function block pairs into nodes; a second transforming apparatus which transforms the nodes into directed acyclic graphs or undirected acyclic graphs; and a building apparatus which builds a graph of the function block chain based on the directed acyclic graphs/undirected acyclic graphs and a weight served by the count.

As another example, some embodiments of the present disclosure include a computer program product, the computer program product is tangibly stored on a computer readable medium and includes a computer executable instruction, and the computer executable instruction enables at least one processor to execute one or more of the methods described when being executed.

As another example, some embodiments of the present disclosure include a computer-readable medium, storing computer-executable instructions, the computer-executable instructions, when being executed, causing at least one processor to perform one or more of the methods described herein.

The graph transformation mechanism of the function block chain makes data of PLC or industrial software more valuable. Compared with the situation of unavailable data in the prior art, the above-mentioned data may be used in the knowledge graph calculation of the present disclosure. The teachings are applicable to all software, which means that all industrial data can be used to perform graph calculation by using the present invention, and this will greatly accelerate building of an industrial knowledge graph network. Moreover, the methods can be automatically executed at an engineering end in time, which means that users can easily adopt the teachings herein, and can collect data and perform data preprocessing at an edge device end. All the prior arts mean information loss, but the teachings herein can ensure that no information is lost, and all the connections of the initial function block chain can be saved in the graph of the subsequently transformed undirected acyclic graph, wherein a number of connections is equal to a sum of edge weights, which proves that all the connections of the initial function block chain are saved. For example, the graph that saves all the information of the initial function block chain can easily perform subsequent machine learning. Moreover, all the true co-occurrence information of the initial cyclic graph can be reflected and saved in the finally transformed acyclic graph.

Although the content of the present disclosure has been described in detail through the above exemplary embodiments, it should be understood that the above description should not be considered as a limitation on the present disclosure. For a person skilled in the art, various modifications and replacements to the embodiments described herein will be apparent after reading the above content. Therefore, the protection scope of the present disclosure should be subject to the appended claims. In addition, any reference numeral in the claims shall not be construed as limiting the claims; the word “include/comprise” does not exclude apparatuses or steps not listed in other claims or the specification; and the terms such as “first” and “second” are only used for indicating the names and do not indicate any particular order.

What is claimed is:

1. A graph transformation method of a function block chain, the method comprising:
extracting a plurality of function block pairs from a function block chain, wherein the function block chain comprises a plurality of function blocks connected in sequence;
respectively transforming the function block pairs into nodes;
transforming the nodes into directed acyclic graphs or undirected acyclic graphs; and
building a graph of the function block chain based on the directed acyclic graphs/undirected acyclic graphs and a weight served by the count.

2. The graph transformation method of a function block chain according to claim 1, wherein the nodes comprise twin nodes.

3. The graph transformation method of a function block chain according to claim 2, the method further comprises:
classifying the function block pairs according to a self-circulation type and a bidirectional circulation type;
counting the function block pairs of the self-circulation type and the bidirectional circulation type respectively; and
respectively transforming the function block pairs of different types into twin nodes.

4. The graph transformation method of a function block chain according to claim 2, wherein the types comprise self-circulation and bidirectional circulation, and the method further comprises:
for the function block of the self-circulation type, transforming the nodes corresponding to the function block into twin nodes of in-degree and out-degree of one connection; and
for the function block of the bidirectional circulation type, duplicating any node corresponding to the function block, and then re-connecting with another node to transform into twin nodes of in-degree and out-degree of two connections.

5. The graph transformation method of a function block chain according to claim 2, wherein the function block pair refers to every two function blocks and a mutual relationship therebetween.

6. The graph transformation method of a function block chain according to claim 1, wherein:
the node comprises a triple node; and
the triple node comprises two adjacent sub-function blocks and a parent function block and mutual connections therebetween.

7. The graph transformation method of a function block chain according to claim 6, further comprising respectively transforming the function block pairs into triple nodes and counting co-occurrences of two adjacent triple nodes.

8. The graph transformation method of a function block chain according to claim 7, wherein, when the function block chain comprises a connecting branch between the function blocks, the sub-function blocks in the triple node on the branch are mutually connected with the parent function block of adjacent nodes.

9. The graph transformation method of a function block chain according to claim 6, wherein, when the triple node is based on the co-occurrence thereof, the graph transformation method of a function block chain further comprises replicating the node based on co-occurrences thereof in the graph to become a twin replicated node, and then connecting the node with the twin node thereof.

10. A graph transformation system of a function block chain, the system comprising:
a processor; and
a memory coupled to the processor, the memory having instructions stored therein, the instructions, when executed by the processor, causing the processor to:
extract a plurality of function block pairs from a function block chain, wherein the function block chain comprises a plurality of function blocks connected in sequence;
respectively transform the function block pairs into nodes;
transform the nodes into directed acyclic graphs or undirected acyclic graphs; and
build a graph of the function block chain based on the directed acyclic graphs/undirected acyclic graphs and a weight served by the count.

11. The graph transformation system of a function block chain according to claim 10, wherein the nodes are twin nodes.

12. The graph transformation system of a function block chain according to claim 11, wherein the actions further comprise:
classifying the function block pairs according to a self-circulation type and a bidirectional circulation type;
counting the function block pairs of the self-circulation type and the bidirectional circulation type respectively; and
respectively transforming the function block pairs of different types into twin nodes.

13. The graph transformation system of a function block chain according to claim 11, wherein the types comprise self-circulation and bidirectional circulation, and the actions further comprise:
for the function block of the self-circulation type, transforming the nodes corresponding to the function block into twin nodes of in-degree and out-degree of one connection; and
for the function block of the bidirectional circulation type, duplicating any node corresponding to the function block, and then re-connecting with another node to transform into twin nodes of in-degree and out-degree of two connections.

14. The graph transformation system of a function block chain according to claim 11, wherein the function block pair refers to every two function blocks and a mutual relationship therebetween.

15. The graph transformation system of a function block chain according to claim 10, wherein:
the node comprise a triple node; and
the triple node comprises two adjacent sub-function blocks and a parent function block and mutual connections therebetween.

16. The graph transformation system of a function block chain according to claim 15, further comprising respectively transforming the function block pairs into triple nodes and counting co-occurrences of two adjacent triple nodes.

17. The graph transformation system of a function block chain according to claim 16, wherein, when the function block chain comprises a connecting branch between the function blocks, the sub-function blocks in the triple node on the branch are mutually connected with the parent function block of adjacent nodes.

18. The graph transformation system of a function block chain according to claim 15, wherein, when the triple node is based on the co-occurrence thereof, the actions further comprise: replicating the node based on co-occurrences thereof in the graph to become a twin replicated node, and then connecting the node with the twin node thereof.

19. A graph transformation apparatus of a function block chain, the apparatus comprising:
an extracting apparatus which extracts a plurality of function block pairs from a function block chain, wherein the function block chain comprises a plurality of function blocks connected in sequence;
a first transforming apparatus which respectively transforms the function block pairs into nodes;
a second transforming apparatus which transforms the nodes into directed acyclic graphs or undirected acyclic graphs; and
a building apparatus which builds a graph of the function block chain based on the directed acyclic graphs/undirected acyclic graphs and a weight served by the count.

20-21. (canceled)
